(19) United States
(12) Patent Application Publication
(10) Pub. No.: US 2023/0331973 A1
(43) Pub. Date: Oct. 19, 2023

(54) BATTERY PACKAGING MATERIAL

(71) Applicant: Resonac Packaging Corporation, Hikone-shi (JP)

(72) Inventor: Keitaro KAWAKITA, Hikone-shi (JP)

(73) Assignee: Resonac Packaging Corporation, Hikone-shi (JP)

(21) Appl. No.: 18/135,655

(22) Filed: Apr. 17, 2023

(30) Foreign Application Priority Data
Apr. 18, 2022 (JP) 2022-068030
Mar. 15, 2023 (JP) 2023-040789

(51) Int. Cl. C08L 33/02; C08K 3/04; C08K 5/17; C08K 5/20; C08K 3/36; C09D 133/02; C09J 7/38; C09J 7/29; B32B 7/12; H01M 50/271

(52) U.S. Cl. CPC C08L 33/02; C08K 3/04; C08K 5/17; C08K 5/20; C08K 3/36; C09D 133/02; C09J 7/381; C09J 7/29; B32B 7/12; H01M 50/271; C08K 2003/3045

(57) ABSTRACT

A battery packaging material includes a substrate layer, a heat-fusible resin layer, a barrier layer arranged between the substrate layer and the heat-fusible resin layer, and a substrate protective layer as an outermost layer arranged on an outer side of the substrate layer. The substrate protective layer contains a binder resin, soft resin fine particles having a glass transition temperature Tg of less than 30° C., hard resin fine particles having a glass transition temperature Tg of 30° C. or higher, and inorganic fine particles, as solid fine particles, and a total content rate of the solid fine particles in the substrate protective layer is 30 mass % to 50 mass %.

### TECHNICAL FIELD

The present invention relates to a packaging material for a power storage device, such as, e.g., a battery and a capacitor used for a mobile device including, e.g., a smartphone or a tablet computer, or a battery or a capacitor used to store electric power for an electric vehicle, wind power generation, solar power generation, and nighttime electricity.

### BACKGROUND OF THE INVENTION

In a production process of a battery, when a surface of a packaging material is damaged, the appearance of the product is impaired. In order to prevent the occurrence of poor appearance during the production process, a method is employed in which a protective tape is adhered to the packaging material, and the protective tape is peeled off after completion of the production. Although the protective tape is required to have adhesive properties to prevent the protective tape from being peeled off during the production process, in a case where it is firmly adhered, the adhesive of the protective tape may remain on the packaging material after the peeling. Further, in a packaging material in which a colored layer containing carbon black is laminated on the surface of the packaging material, the colored layer may also be peeled off together with the protective tape.

With respect to such a problem of the protective tape, the adhesive residues after peeling the protective layer have been conventionally addressed by the adhesive force of the protective tape (see Patent Document 1). Further, a technique for strengthening a colored layer has been proposed to cope with the peeling of the colored layer (see Patent Document 2).

### PRIOR ART DOCUMENT

### Patent Document

### Patent Document 1: Japanese Unexamined Patent Application Publication No. 2020-155364

### Patent Document 2: Japanese Unexamined Patent Application Publication No. 2006-206805

### SUMMARY OF THE INVENTION

### Problems to be Solved by the Invention

However, the technique disclosed in Patent Document 1 is not a measure to prevent adhesive residues on the packaging material. Further, the technique disclosed in Patent Document 2 does not solve the problem of adhesive residues for the packaging material in which the outermost layer is not a colored layer containing carbon black.

Preferred embodiments of the present invention have been made in view of the above-described and/or other problems in the related art. Preferred embodiments of the present invention can significantly improve upon existing methods and/or devices.

### Means for Solving the Problems

In view of the above-described background technique, the present invention aims to impart conflicting properties of preventing unintentional peeling of a protective tape and enabling peeling without leaving adhesives of the protective tape on a surface of a battery packaging material and to prevent appearance deterioration due to residues of the adhesive of the protective tape.

Other objects and advantages of the present invention will be apparent from the following preferred embodiments.

That is, the present invention has the configuration recited in the following items [1] to [11].
[1] A battery packaging material comprising:
   a substrate layer;
   a heat-fusible resin layer;
   a barrier layer arranged between the substrate layer and the heat-fusible resin layer; and
   a substrate protective layer as an outermost layer arranged on an outer side of the substrate layer,
   wherein the substrate protective layer contains a binder resin, soft resin fine particles having a glass transition temperature Tg of less than 30° C., hard resin fine particles having a glass transition temperature Tg of 30° C. or higher, and inorganic fine particles, as solid fine particles, and
   wherein a total content rate of the solid fine particles in the substrate protective layer is 30 mass % to 50 mass %.
[2] The battery packaging material as recited in the above-described Item [1],
   wherein the soft resin fine particles have an average particle diameter of 5 μm to 20 μm, the hard resin fine particles have an average particle diameter of 1 μm to 15 μm, and the inorganic fine particles have an average particle diameter of 1 μm to 10 μm.
[3] The battery packaging material as recited in the above-described Item [1] or [2],
   wherein in the substrate protective layer, a content rate of the soft resin fine particles is 1 mass % to 10 mass %, a content rate of the hard resin fine particles is 1 mass % to 20 mass %, and a content rate of the inorganic fine particles is 20 mass % to 40 mass %.
[4] The battery packaging material as recited in any one of the above-described Items [1] to [3],
   wherein the soft resin fine particles are at least one selected from the group consisting of polyethylene wax, polypropylene wax, polyethylene resin beads, and urethane resin beads.
[5] The battery packaging material as recited in any one of the above-described Items [1] to [4],
   wherein the hard resin fine particles are at least one selected from the group consisting of polytetrafluoroethylene wax, acrylic resin beads, polystyrene resin beads, and fluororesin beads.
[6] The battery packaging material as recited in any one of the above-described Items [1] to [5],
   wherein the inorganic fine particles are at least one selected from the group consisting of silica, alumina, kaolin, calcium oxide, calcium carbonate, calcium sulfate, barium sulfate, and calcium silicate.
[7] The battery packaging material as recited in any one the above-described Items [1] to [6],
   wherein the binder resin of the substrate protective layer is at least one selected from the group consisting of an acryl-based resin, a urethane-based resin, a polyolefin-based resin, a phenoxy-based resin, a polyester-based resin, a tetrafluoro olefin-based resin.
[8] The battery packaging material as recited in any one of the above-described Items [1] to [7],
   wherein at least one of the substrate protective layer and the substrate layer contains a coloring agent.
[9] The battery packaging material as recited in any one of the above-described Items [1] to [7],
   wherein the barrier layer and the substrate layer are laminated via an adhesive layer, and at least one of the substrate protective layer, the substrate layer, and the adhesive layer contains a coloring agent.
[10] The battery packaging material as recited in any one of the above-described Items [1] to [7], further comprising:
   a colored layer provided at least one of between the substrate protective layer and the substrate layer, and between the substrate layer and the barrier layer.
[11] The battery packaging material as recited in any one of the above-described Items [1] to [7], further comprising:
   wherein the barrier layer and the substrate layer are laminated via an adhesive layer, and
   wherein a colored layer is provided at least one between the substrate protective layer and the substrate layer, between the substrate layer and the adhesive layer, and between the adhesive layer and the barrier layer.

### Effects of the Invention

In the battery packaging material as recited in the above-described Item [1], the substrate protective layer contains a binder resin, soft resin solid fine particles and hard resin hard resin fine particles having different hardness, and inorganic fine particles. Therefore, the surface includes a portion where the binder resin is present and a portion where the solid fine particles having three different hardness are present. The portion where the binder resin is present is easily contacted by the adhesive of the protective tape, the adhesive strength is strong, and the portion where the solid fine particles are present is hard to be contacted by the adhesive, and the adhesive strength is weak. Further, since there are three types of solid fine particles that differ in hardness, the strength of the adhesive force varies depending on the solid fine particles.

Further, since the total content rate of the solid fine particles is specified to be 30 mass % to 50 mass %, the area of the portion having strong adhesive force and the area of the portion having weak adhesive force are balanced. Therefore, the protective tape can be easily peeled off after being used while keeping sufficient adhesive strength when required, and adhesive residues after peeling are less likely to be generated.

Further, when the battery packaging material is heated and pressed (or compressed) during curing in the battery production process, the soft resin fine particles and the hard resin fine particles are soften and deformed flatly according to their glass transition temperatures Tg, resulting in high adhesiveness of the protective tape. Thus, the protective tape becomes difficult to be peeled off. On the other hand, since the inorganic fine particles are very hard and hardly deformed, they maintain the easy peeling effect and prevents significant deformation of the soft resin fine particles and the hard resin fine particles, and prevents the soft resin fine particles and the hard resin fine particles from being buried in the binder resin. By using three types of solid fine particles having differing hardness, it is possible to suppress an increase in adhesive force due to heat and pressure and to maintain the easy peeling property.

According to the battery packaging material as recited in the above-described Item [2], since three types of average particle diameters of the solid fine particles are defined, the timing at which the adhesive is peeled off shifts, the cohesive failure of the adhesive hardly occurs, and the adhesive residues hardly occur.

According to the battery packaging material recited in the above-described Item [3], since the content rates of three types of solid fine particles are defined, and a large amount of inorganic fine particles is blended, the effect of inhibiting the contact between the adhesive of the protective tape and the binder resin at the time of heating and pressing (or compressing) is large, and the occurrence of adhesive residue can be suppressed.

According to the battery packaging material as recited in the above-described Item [4], since the selected soft resin fine particles are easily deformed by being softened at the time of heating and pressing (or compressing), appropriate peeling strength for the adhesive of protective tape can be obtained.

According to the battery packaging material as recited in the above-described Item [5], since the selected hard resin fine particles are slightly deformed by a synergistic effect between the temperature and the pressure at the time of heating and pressing (or compressing), the contact area of the protective tape with the adhesive is slightly increased, which contributes to the peeling strength.

According to the battery packaging material as recited in the above-described Item [6], since the selected inorganic fine particles are less likely to be deformed when heated and pressurized, an appropriate peeling strength with the adhesive of the protective tape can be obtained.

According to the battery packaging material as recited in the above-described Item [7], since the selected binder resin and the adhesion of the protective tape have good adhesion suitability, the adhesive strength can be differentiated between the portion where the binder resin is present and the portion where the solid fine particles are present.

The battery packaging material as recited in the above-described Items [8], [9], [10], and [11] is colored by a coloring agent. Therefore, the visibility of the adhesive residue portion of the protective tape is improved, and the adhesive residue determination can be easily performed. Further, the design properties can also be imparted.

### BRIEF DESCRIPTION OF THE DRAWINGS

FIG. 1 is a cross-sectional view showing one example of a battery packaging material according to the present invention.

FIG. 2 is a cross-sectional view of a battery packaging material to which a protective tape is adhered when heated and pressurized.

FIG. 3 is a cross-sectional view showing another example of a battery packaging material according to the present invention.

### EMBODIMENTS FOR CARRYING OUT THE INVENTION

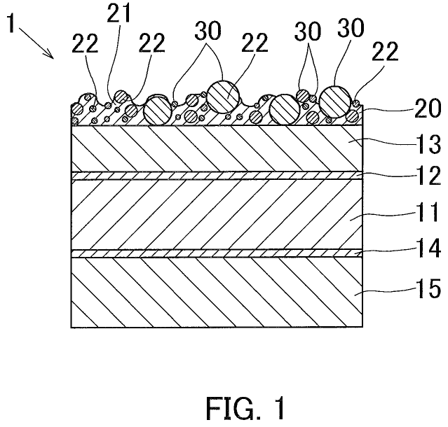

FIG. 1 shows one embodiment of a battery packaging material according to the present invention.

In the following description, a layer assigned by the same reference symbol represents the same or equivalent layer, and therefore, the duplicate description thereof will be omitted.

Note that, in this specification, when the position of each layer constituting the battery packaging material is described with directions, the direction toward the substrate protective layer is referred to as an outer side, and the direction toward the heat-fusible resin layer is referred to as an inner side.

### Embodiment of Battery Packaging Material

In the battery packaging material 1 shown in FIG. 1, a substrate layer 13 is bonded to one surface of a barrier layer 11 via a first adhesive layer 12, a heat-fusible resin layer 15 is bonded to the other surface of the barrier layer 11 via a second adhesive layer 14, and a substrate protective layer 20 is laminated on the substrate layer 13.

### Use of Protective Tape in Battery Production Process

A battery case is made by three-dimensionally molding the battery packaging material 1 to form a convex portion, and the molded battery packaging materials 1 are placed with the heat-fusible resin layers 15 faced to each other. A battery element and an electrolyte are filled in the case, and the periphery of the convex portion is heat-sealed. Further, curing and degassing are performed. Thus, a battery is produced. In the process from the molding of the battery packaging material 1 to the degassing, for the purpose of protecting the battery packaging material 1, a protective tape is attached to the top surface of the convex portion and the non-heat-sealed area, and curing and degassing are performed with the protective tape attached.

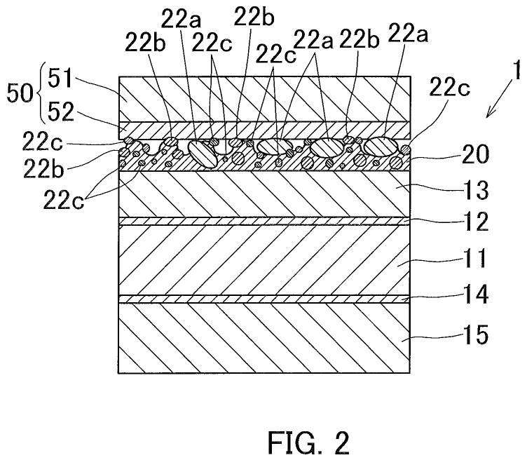

The curing is performed by heating to 50° C. to 80° C. and holding the state of being pressed (or compressed) in the lamination direction at 0.3 MPa to 0.7 MPa for 1 hour to 24 hours. FIG. 2 shows a state in which the battery packaging material 1 to which the protective tape 50 is attached is heated and pressurized. The protective tape 50 is a sheet formed by coating an adhesive 52 on one side of the substrate 51.

The cured and degassed battery is shipped with the protective tape 50 peeled off.

Therefore, the outer surface of the battery packaging material 1 needs to have contradictory characteristics that the attached protective tape 50 needs to be firmly attached to the outer surface of the battery packaging material 1 without being unintentionally peeled off, and when the protective tape 50 becomes unnecessary, the protective tape 50 can be cleanly peeled off without leaving the adhesive 52 and without damaging the adhered surface.

### Substrate Protective Layer

The substrate protective layer 20 is a layer for imparting excellent slipperiness to the surface of the battery packaging material 1 to improve moldability and for imparting excellent chemical resistance, solvent resistance, and abrasion resistance.

The substrate protective layer 20 is a cured film of resin compositions containing a binder resin 21 and three types of solid fine particles 22 described later. Some of the solid fine particles 22 in the cured film are buried in the binder resin 21, but some of them protrude outward from the surface of the binder resin 21 to form protrusions 30. Therefore, on the surface of the substrate protective layer 20, not only ultrafine unevenness by the binder resin 21 but also large unevenness by the protrusions 30 are formed.

Since the protrusions 30 protrude high on the surface of the substrate protective layer 20, the adhesive of a protective tape 50 comes into contact with the top area of the protrusions 30 but hardly comes into contact with the inclined portions around them. On the other hand, since the areas other than the protrusions 30 are smoother than the protrusions 30, the adhesive easily comes into contact thereto. An area which is less likely to come into contact with the adhesive has a small contact amount of the adhesive, and thus has weak adhesive strength (adhesiveness), and an area which is likely to come into contact with the adhesive has a large contact amount of the adhesive, and thus has strong adhesive strength (adhesiveness). As described above, since a state is generated in which the area in which the contact amount of the adhesive is large and the area in which the contact amount of the adhesive is small are finely mixed on the surface of the substrate protective layer 20, it is possible to easily separate the protective tape 50 after use while keeping adhesive strength when needed, and adhesive residues are less likely to be generated after peeling.

The balance between the adhesive strength of the protective tape 50 when needed and the easy peeling property after use is influenced by the compositions of the resin compositions constituting the substrate protective layer 20 and the properties of solid fine particles to be used, and the proper balance can be obtained by specifying them.

The resin compositions constituting the substrate protective layer 20 contains a binder resin 21 and three types of solid fine particles 22, i.e., soft resin fine particles, hard resin fine particles, and inorganic fine particles. In the present invention, the hardness and the softness of the resin fine particles are distinguished based on a glass transition temperature Tg, resin particles having a glass transition temperature Tg of less than 30° C. are defined as soft resin fine particles, and resin particles having a glass transition temperature Tg of 30° C. or higher are defined as hard resin fine particles.

The glass transition temperature Tg is a temperature at which the molecular chains of the resin particles start a micro-Brown motion and is represented by the start temperature (onset point) of heat absorption by differential scanning calorimetry (DSC) analysis. The glass transition temperature Tg can be measured by JIS K7121-1987 “Plastic Transition Temperature Measuring Method.”

Three types of solid fine particles are different in hardness, soft resin fine particles are the softest, and inorganic fine particles are the hardest. Further, these three types of solid fine particles differ in hardness from the cured binder resin 21. Since the protrusions 30 are formed by the solid fine particles 22 on the surface of the substrate protective layer 20, portions having different hardness due to the resin binder 21 and the three types of solid fine particles 22 are present on the surface of the substrate protective layer 20.

The ease of separation of the adhesive of the protective tape 50 varies depending on the hardness of the attachment surface. The portion where the binder resin 21 is present is likely to be contacted by the adhesive of protective tape 50, and the adhesive strength is strong. The portion where solid fine particles are present is less likely to be contacted by the adhesive, and the adhesive strength is weak. Further, since there are three types of solid fine particles having different hardness, the adhesive force varies depending on the solid fine particles. When the protective tape 50 is peeled off from the substrate protective layer 20 having the surface described above, the timing at which the adhesive is peeled off shifts at portions different in hardness, and the force applied to the adhesive is dispersed. Therefore, the cohesive fracture of the adhesive is unlikely to occur, and the adhesive residue is unlikely to occur.

Further, as shown in FIG. 2, curing performed by heating and pressing (or compressing) after heat sealing in the battery production process is performed in a state in which the protective tape 50 adheres to the battery packaging material 1. When the battery packaging material 1 is pressurized in the lamination direction while being heated, a change occurs in each of three types of solid fine particles according to their characteristics.

The soft resin fine particles 22a having a glass transition temperature Tg of less than 30° C. is softened and deformed flatly, thereby increasing the contact area with the adhesive 52. This enhances the adhesive properties of the protective tape 50, and therefore, the protective tape 50 becomes less likely to be peeled off. The hard resin fine particles 22b having a glass transition temperature Tg of 30° C. or higher also softens, but the degree of deformation is smaller than that of soft resin fine particles 22a, so that the increased amount of the contact area with the adhesive 52 is reasonable, and the effects of enhancing the adhesiveness is smaller than that of soft resin fine particles 22a. The inorganic fine particles 22c are very hard and hardly deformed. Therefore, there is no change in the contact area with the adhesive 52, and easy peeling effect by the protruding particles (protrusion 30) is maintained.

Further, the inorganic fine particles 22c prevent significant deformation of the soft resin fine particles 22a and the hard resin fine particles 22b and prevent the soft resin fine particles 22a and the hard resin fine particles 22b from being buried in the binder resin 21. When the battery packaging material 1 is heated and pressurized, the adhesive force of the protective tape 50 is increased, but by using three types of solid fine particles different in hardness, the easy peeling property can be maintained by suppressing the increase in the adhesive strength due to the heating and the pressurization.

The total content rate of the solid fine particles in the substrate protective layer 20 is set to 30 mass % to 50 mass %. When the total content rate of the solid fine particles is less than 30 mass %, the protrusion 30 on the surface of the substrate protective layer 20 becomes low, so that adhesive properties of the protective tape 50 becomes high, and peeling strength becomes high, so that adhesive residues are likely to be generated. On the other hand, when the total content rate of the solid fine particles exceeds 50 mass %, the adhesive residues are less likely to be generated, but since adhesive properties of the protective tape 50 are lowered, unintentional peeling is likely to occur during handling. A particularly preferred total content rate is 35 mass % to 45 mass %.

The content rate of each fine particle in the substrate protective layer 20 is preferably 1 mass % to 10 mass % for the soft resin fine particles, 1 mass % to 20 mass % for the hard resin fine particles, and 20 mass % to 40 mass % for the inorganic fine particles. The particularly preferable content rate of the respective fine particles is 2 mass % to 8 mass % for the soft resin fine particles, 3 mass % to 12 mass % for the hard resin fine particles, and 25 mass % to 35 mass % for the inorganic fine particles.

As for the relation between the contents of the three types of solid fine particles, the inorganic fine particles are preferably larger than the total of the soft resin fine particles and the hard resin fine particles. By blending a large amount of the inorganic fine particles, the effect of inhibiting the contact between the adhesive of the protective tape 50 and the binder resin 21 at the time of heating and pressurization is large, which in turn can suppress the occurrence of adhesive residues. It should be noted that the total content rate of the solid fine particles and the content rate of each solid fine particle are the ratio to the total of the binder resin and the solid fine particles, and do not include a solvent used to adjust the viscosity at the time of coating.

The average particle diameter of the soft resin fine particles is preferably 5 μm to 20 μm, the average particle diameter of the hard resin fine particles is preferably 1 μm to 15 μm, and the average particle diameter of the inorganic fine particles is preferably 1 μm to 10 μm. The particularly preferable average particle diameter is 6 μm to 18 μm for the soft resin fine particles, 3 μm to 12 μm for the hard resin fine particles, and 1 μm to 3 μm for the inorganic fine particles. The contact area with the adhesive of the protective tape 50 differs depending on the particle diameter of the solid fine particles, and therefore, the adhesive force differs. Therefore, by setting the average particle size of the three types of solid fine particles to the above-described range, the peeling timing of the adhesive shift, the cohesive failure of the adhesive is less likely to occur, and the adhesive residues are less likely to occur.

Further, it is preferable that the average particle diameter of the three types of solid fine particles satisfy the relation of the soft resin fine particles>the hard resin fine particles>the inorganic fine particles. As described above, the soft resin fine particles and the hard resin fine particles are deformed into a flat shape by heating and pressurization for the battery curing to increase the contact area with the adhesive of the protective tape 50, thereby increasing the adhesive force, and the inorganic fine particles are not deformed, thereby suppressing the deformation of the two types of resin fine particles. When the average particle diameters of the three types of solid fine particles satisfy the above-described relation, the adhesive force and the easy peeling property are well balanced, and the generation of adhesive residues is suppressed.

The solid fine particles are required to contain at least one from each category of soft resin fine particles, hard resin fine particles, and inorganic fine particles, and may contain two or more from one category. Further, the fine particles belonging to each category can be exemplified as follows.

Examples of the soft resin fine particles, i.e., the resin fine particles having a glass transition temperature Tg of less than 30° C. include polyethylene wax, polypropylene wax, polyethylene resin beads, and urethane resin beads. These fine particles provide appropriate peeling strength for the adhesive of the protective tape 50 due to the glass transition temperature Tg. Among the above-mentioned soft resin fine particles, the polyethylene wax and polyethylene resin beads have lower glass transition temperatures Tg and melting points, and the softening point of the polyethylene is 85° C. to 120° C. Therefore, they are softened and easily deformed in the vicinity of the temperature (50° C. to 80° C.) of the heating/pressing (or compressing) step during curing and thus can be recommended in terms of improving the peeling strength of the protective tape 50 with the adhesive.

Examples of hard resin fine particles, i.e., resin fine particles having a glass transition temperature Tg of 30° C. or higher include polytetrafluoroethylene wax, acrylic resin beads, polystyrene resin beads, and fluororesin beads. All these fine particles have a glass transition temperature Tg of around 100° C. and are hardly softened at the temperature (50° C. to 80° C.) of the heating and pressing (or compressing) process for curing after adhesion of the protective tape 50, but they are slightly deformed under synergistic effects with the pressure, and the contact area with the adhesive of the protective tape 50 is slightly increased, which contributes to the peeling strength.

Further, among the above-mentioned hard resin fine particles, polytetrafluoroethylene wax is most excellent in chemical resistance, and when the substrate protective layer 20 is required to have electrolyte resistance, this wax is preferably used.

As the inorganic fine particles, silica, alumina, kaolin, calcium oxide, calcium carbonate, calcium sulfate, barium sulfate, and calcium silicate can be exemplified. All these inorganic fine particles are harder than soft resin fine particles and hard resin fine particles described above, and are less likely to deform in the heating and pressing (or compressing) process, appropriate peeling strength can be obtained as the adhesive of a protective tape 50. Further, among these inorganic fine particles, silica is recommended because it has a small-grade average particle diameter and is easy to obtain fine particles having the desired average particle diameter, and it is easy to disperse them in various binder resins.

As the binder resin 21, at least one type of a resin selected from the group consisting of an acryl-based resin, a urethane-based resin, a polyolefin-based resin, a phenoxy-based resin, and a polyester-based resin is preferably used. Since these resins have good adhesion suitability to the adhesive of a protective tape 50, the adhesive strength can be differentiated between the portion where the binder resin is present and the portion where the solid fine particles are present. Further, these resins have higher chemical resistance and solvent resistance, and therefore, the solid fine particles are less likely to fall off due to degradation of the resin or the like. Among these resins, particularly preferred resins are a urethane-based resin, a polyester urethane-based resin, and a urethane phenoxy-based resin.

Further, the binder resin may be composed of a main agent containing at least one of the above-described resins and a curing agent for curing the main agent. The curing agent is not particularly limited and may be appropriately selected depending on the main agent. As the curing agent, an isocyanate compound, such as, e.g., hexamethylene diisocyanate (HDI), isophorone diisocyanate (IPDI), tolylene diisocyanate (TDI), diphenylmethane diisocyanate (MDI), xylylene diisocyanate (XDI), or a modified product of these isocyanate compounds may be exemplified.

The curing agent is preferably blended in the amount of 5 parts by mass to 30 parts by mass with respect to 100 parts by mass of the main agent. When it is less than 5 parts by mass, adhesive property and solvent resistance to the substrate layer 13 may be reduced. When it exceeds 30 parts by mass, the substrate protective layer 20 becomes hard, which may deteriorate the formability.

Further, a lubricant and/or a surfactant may be added to the substrate protective layer 20, in addition to the binder resin 21 and the solid fine particles 22. The lubricant and the surfactant are effective in lowering the adhesive force of the adhesive of the protective tape 50, and they are precipitated on the surface of the substrate protective layer 20, which improves the peeling property of the protective tape 50 and causes the adhesive residues to be less likely to occur.

As the lubricant, the following various amides can be exemplified.

As the saturated fatty acid amides, lauramide, palmitamide, stearamide, behenamide, and hydroxyl stearamide can be exemplified.

As unsaturated fatty acid amides, oleamide and erucamide can be exemplified.

As substituted amides, N-oleylpalmitamide, N-stearyl stearamide, N-stearyl oleamide, N-oleyl stearamide, and N-stearyl erucamide can be exemplified.

As methylolamides, methylol stearamide can be exemplified.

As saturated fatty acid bisamides, methylenebisstearic acid amide, ethylenebiscapric acid amide, ethylenebislaulic acid amide, ethylenebisstearic acid amide, ethylenebishydroxystearic acid amide, ethylenebisbehenic acid amide, hexamethylenebisstearic acid amide, hexamethylenebisbehenic acid amide, hexamethylenehydroxystearic acid amide, N,N′-distearyladipic acid amide, N,N′-distearylsebacic acid amide can be exemplified.

As unsaturated fatty acid bisamides, ethylenebisoleic acid amide, ethylenebiserucic acid amide, hexamethylenebisoleic acid amide, N,N′-dioleyladipic acid amide, and N,N′-dioleylsebacic acid amide can be exemplified.

As fatty acid ester amides, steariylamide ethyl stearate can be exemplified.

As aromatic bisamides, m-xylylene bisstearic acid amide, m-xylylene bishydroxystearic acid amide, and N,N′-cystearyl isophthalic acid amide can be exemplified.

As the surfactant, an anionic surfactant, a cationic surfactant, and a nonionic surfactant can be exemplified.

The preferred thickness of the substrate protective layer 20 is 1 μm to 12 μm, and the particularly preferred thickness is 2 μm to 10 μm.

The preferred materials of layers other than the substrate protective layer 20 in the battery packaging material 1 are as follows.

### Barrier Layer

The barrier layer 11 is responsible for providing the battery packaging material 1 with a gas barrier property for preventing oxygen/water from entering. As the barrier layer 11, it is not particularly limited, but a metal foil, such as, e.g., an aluminum foil, a SUS foil (stainless-steel foil), a copper foil, a nickel foil, a titanium foil, and a clad foil can be exemplified. Among them, an aluminum foil can be suitably used as the barrier layer 11. In particular, in the case of using an Al—Fe-based alloy foil containing Fe of 0.7 mass % to 1.7 mass %, excellent strength and ductility can be obtained, resulting in good moldability. The thickness of the barrier layer 11 is preferably 20 μm to 100 μm. When the thickness is 20 μm or more, it is possible to prevent the generation of pinholes at the time of rolling when producing a metal foil, and when the thickness is 100 μm or less, it is possible to reduce stress at the time of molding, such as, e.g., stretch forming and drawing, which in turn can improve the formability. The particularly preferred thickness of the barrier layer 11 is 30 μm to 80 μm.

Further, it is preferable that the barrier layer 11 is subjected to a base treatment, such as, e.g., a chemical conversion treatment, on at least a surface of the metal foil on the side of the heat-fusible resin layer 15. By being subjected to such a chemical conversion treatment, it is possible to sufficiently prevent the metal foil surface from being corroded due to contents (such as, e.g., electrolytes of a battery).

### Substrate Layer

As the substrate layer 13, a heat-resistant resin film that does not melt at the heat-sealing temperature at the time of heat-sealing the battery packaging material 1 is used. As the heat-resistant resin, a heat-resistant resin having a melting point higher than the melting point of the resin constituting the heat-fusible resin layer 15 by 10° C. or more, preferably 20° C. or more, is used.

The examples of the resin satisfying this condition include a polyamide film and a polyester film such as a nylon film, and these stretched films are preferably used. Among them, as the substrate layer 13, it is particularly preferred to use a biaxially stretched polyamide film, such as, e.g., a biaxially stretched nylon film, a biaxially stretched polybutylene terephthalate (PBT) film, a biaxially stretched polyethylene terephthalate (PET) film, or a biaxially stretched polyethylene naphthalate (PEN) film. The examples of the nylon film include, but not particularly limited thereto, a 6 nylon film, a 6, 6 nylon film, and an MXD nylon film.

Note that the substrate layer 13 may be formed of a single layer, or may be formed of, for example, a multilayer (a multilayer formed of a PET film/a nylon film) formed of a polyester film/a polyamide film.

The thickness of the substrate layer 13 is preferably 9 μm to 50 μm, which makes it possible to secure sufficient strength as a packaging material and to reduce stresses at the time of forming, such as, e.g., stretch forming and drawing, to improve the formability. The preferable thickness of the substrate layer 13 is 12 μm to 30 μm.

### Heat-Fusible Resin Layer

The heat-fusible resin layer 15 imparts excellent chemical resistance against an electrolyte having high corrosiveness and has a role of imparting a heat-sealing property to the battery packaging material 1.

The resin constituting the heat-fusible resin layer 15 is preferably a polyolefin-based resin single-layer or a multilayer film made of, e.g., a propylene-based resin, and is preferably a non-stretched film. As the propylene-based resin, an ethylene-propylene copolymer containing ethylene and propylene as a copolymerization component can be exemplified. The ethylene-propylene copolymer may be either a random copolymer or a block-copolymer. As a multilayer ethylene-propylene copolymer film, a three-layer film of random copolymer-block copolymer-random copolymer can be recommended. The multilayer film can be produced by coextrusion or the like.

The thickness of the heat-fusible resin layer 15 is preferably 20 μm to 100 μm, more preferably 30 μm to 80 μm. The ratio of the thickness of each layer of the three-layer film of the above-described random copolymer-block copolymer-random copolymer is preferably 1 to 3:4 to 8:1 to 3.

The heat-fusible resin layer 15 may contain a lubricant. The type of the lubricant is similar to that added to the substrate protective layer 20, and fatty acid amides are particularly preferred. Further, the lubricant content in the heat-fusible resin layer 15 is preferably 500 ppm to 3,000 ppm. Generally, in the production process of the battery packaging material 1, all layers are laminated and then wound on a roll to be aged. The lubricant in the heat-fusible resin layer 15 is precipitated on the surface by aging and transferred to the substrate protective layer 20, which contributes to suppress the generation of adhesive residues of the protective tape.

### First Adhesive Layer

The first adhesive layer 12 is exemplified by, but not particularly limited thereto, an adhesive layer made of, e.g., a two-part curing type adhesive agent.

As the two-part curing type adhesive, a two-part curing type adhesive composed of a first liquid (main agent) and a second liquid (curing agent) can be exemplified, wherein the first liquid is made of one or more types of polyols selected from the group consisting of a polyurethane-based polyol, a polyester-based polyol, a polyether-based polyol, and a polyester urethane-based polyol, and the second liquid is composed of isocyanate. Among them, it is preferable to use a two-part curing type adhesive agent composed of a first liquid composed of one or two or more types of polyols selected from the group consisting of a polyester-based polyol and a polyester urethane-based polyol, and a second liquid (curing agent) composed of isocyanate. The preferred thickness of the first adhesive layer 12 is 2 μm to 5 μm.

### Second Adhesive Layer

The second adhesive layer 14 is recommended to use, but not particularly limited thereto, an adhesive containing at least one type of a polyurethane-based resin, an acryl-based resin, an epoxy-based resin, a polyolefin-based resin, an elastomer-based resin, a fluororesin-based resin, and an acid-modified polypropylene resin. Among them, an adhesive agent made of a polyurethane composite resin having acid-modified polyolefin as a main agent is preferable. The preferred thickness of the second adhesive layer 14 is 2 μm to 5 μm.

Note that the first adhesive layer 12 and the second adhesive layer 14 are not essential layers, and the substrate layer 13 may be directly bonded to the barrier layer 11, and the heat-fusible resin layer 15 may be directly bonded to the barrier layer 11.

### Coloring Agent

In the battery packaging material 1, by adding a coloring agent or newly providing a colored layer to the previously described layer, it is possible to mask the metallic color of the barrier layer and color it to a desired color, impart design to the packaging material, and make it easier to find adhesive residues of the protective tape 50.

In the case of coloring the pre-existing layer, a coloring agent is added to at least one of the substrate protective layer 20, the substrate layer 13, and the first adhesive layer 12. Note that in the battery packaging material not having a first adhesive layer, a coloring agent is added to the substrate protective layer 13 and/or the substrate layer 11. The coloring agent may be either a pigment or a dye, and may be one type of a coloring agent or may be a combination of two or more types of coloring agents. Specific examples of the coloring agent include carbon black, calcium carbonate, titanium oxide, zinc oxide, iron oxide, aluminum powder, an azo-based pigment, and a phthalocyanine-based pigment. The coloring agent concentration in each layer is preferably 0.5 mass % or more and less than 5 mass %.

In the case of newly providing a colored layer, the colored layer is provided between at least one of between the substrate protective layer 20 and the substrate layer 13, between the substrate layer 13 and the first adhesive layer 12, and between the first adhesive layer 12 and the barrier layer 11. Note that in the battery packaging material not having a first adhesive layer, a colored layer is provided between the substrate protective layer 20 and the substrate layer 13 and/or between the substrate layer 13 and the barrier layer 11. The thickness of the colored layer is preferably 1 μm to 10 μm. The colored layer is preferably made of colored resin compositions in which the above-described coloring agent is added to a main agent made of a main agent, such as, e.g., diamine and polyol, and a curing agent. Further, the concentration of the coloring agent of the colored resin composition is preferable 5 mass % or more and 50 mass % or less.

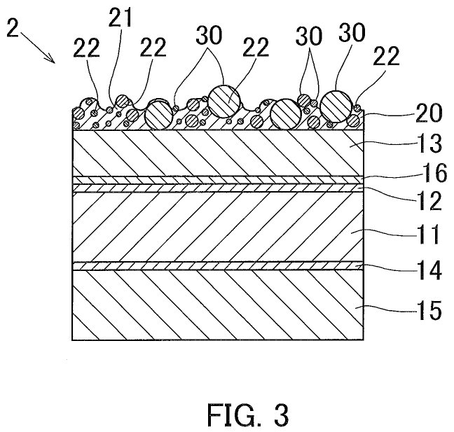

The battery packaging material 2 shown in FIG. 3 is provided with a colored layer 16 between the substrate layer 13 and the first adhesive layer 12.

### EXAMPLES

Battery packaging materials 3 each having the structure shown in FIG. 3 were prepared as Examples and Comparative Examples. The materials common to each example are as follows.

### Common Material

As the barrier layer 11, a layer was used in which a chemical conversion treatment solution composed of phosphoric acid, polyacrylic acid (acryl-based resin), chromium (III) salt compound, water, and alcohol was applied to both surfaces of an aluminum foil made of A8021-O having a thickness of 40 μm, and then dried at 180° C. to thereby form a chemical conversion coating film. The chromium adhesion amount of this chemical conversion coating film was 10 mg/m² per one side.

As the substrate layer 13, a biaxially stretched 6-nylon film having a thickness of 15 μm was used.

As the colored layer 16, a black colored layer having a thickness of 3 μm was formed on one side of the substrate layer 13 by applying colored resin compositions containing carbon black, diamine, a polyester-based polyol, and a curing agent and allowing it to stand at 40° C. for one day to proceed the crosslinking with drying. That is, the colored layer 16 and the substrate layer 13 were integrated into a two-layer film, and the two-layer film was bonded to another layer.

As the heat-fusible resin layer 15, a non-stretched polypropylene film having a thickness of 30 μm containing 3,000 ppm of erucamide as a lubricant was used.

As the first adhesive layer 12, a two-part curing type urethane-based adhesive agent was used.

As the second adhesive layer 14, a two-part curing type maleic acid-modified propylene adhesive agent was used.

As a solvent to be added to the resin composition of the substrate protective layer 20, a mixture of 50 parts by mass of methyl ethyl ketone and 50 parts by mass of toluene were used.

### Example 1

A resin composition and a coating composition for forming the substrate protective layer 20 were prepared by the following method.

A Polyester polyol was used as a main agent, and an adduct (“A” in Table 1) composed of trimethylolpropane and hexamethylene diisocyanate (HDI) was used as a curing agent. 49 parts by mass of the main agent were blended with 11 parts by mass of the curing agent to prepare a binder resin.

Four types of solid fine particles, i.e., polyethylene wax as soft resin fine particles, acrylic resin beads as hard resin fine particles, silica as inorganic fine particles, and barium sulfate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition. The total content rate of the solid fine particles in the resin composition was as shown in Table 1.

Then, a first adhesive layer 12 having a thickness of 3 μm was formed on one surface of the barrier layer 11, and the surface of the colored layer 16 of the substrate layer 13 (two-layer film) with a colored layer 16 was overlaid via the first adhesive layer 12 and dry-laminated. Next, a second adhesive layer 14 having a thickness of 3 μm was formed on the other surface of the barrier layer 11, and a heat-fusible resin layer 15 was laminated via the second adhesive layer 14, sandwiched and pinched between a rubber nip roll and a laminate roll heated to 100° C. and then dry-laminated. This resulted in a six-layer film in which the substrate layer 13, the colored layer 16, the first adhesive layer 12, the barrier layer 11, the second adhesive layer 14, and the heat-fusible resin layer 15 were laminated in order from the outside to the inside.

Next, a coating composition for the substrate protective layer 20 was applied to the surface of the six-layer substrate layer 13, dried, wound on a roll, and aged at 40° C. for 10 hours. The thickness of the substrate protective layer 20 after aging was 2.5 μm, and a seven-layer battery packaging material 2 was obtained.

### Example 2

A resin composition and a coating composition for forming the substrate protective layer 20 were prepared by the following method.

The same main agent and curing agent as those of Example 1 were blended at a ratio of 10 parts by mass of the curing agent with respect to 48 parts by mass of the main agent to prepare a binder resin.

Four types of solid fine particles, i.e., polyethylene wax as soft resin fine particles, polystyrene resin beads as hard resin fine particles, silica as inorganic fine particles, and barium sulfate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition.

The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 2.5 μm.

### Example 3

A resin composition and a coating composition for forming the substrate protective layer 20 were prepared by the following method.

An acrylic polyol was used as a main agent, and the same curing agent as in Example 1 was used to prepare a binder resin in which 9 parts by mass of the curing agent was mixed with 46 parts by mass of the main agent.

Four types of solid fine particles, i.e., polyethylene resin beads as soft resin fine particles, polytetrafluoroethylene wax as hard resin fine particles, alumina as inorganic fine particles, and barium sulfate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition. The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 2 μm.

### Example 4

A resin composition and a coating composition for forming the substrate protective layer 20 were prepared by the following method.

A copolymer of tetrafluoro olefin and carboxylic acid vinyl ester was used as a main agent, the same curing agent as Example 1 was used, and a mixture of 43 parts by mass of the main agent and 8 parts by mass of the curing agent was used as a binder resin.

Four solid fine particles, i.e., polyethylene resin beads as soft resin fine particles, polytetrafluoroethylene wax as hard resin fine particles, silica as inorganic fine particles, and barium sulfate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition. The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 1.5 μm.

### Example 5

A resin composition and a coating composition for forming the substrate protective layer 20 were prepared by the following method.

The same main agent and curing agent as those of Example 1 were used, and 12 parts by mass of the curing agent was blended with 53 parts by mass of the main agent to prepare a binder resin.

Four types of solid fine particles, i.e., polyethylene wax as soft resin fine particles, polystyrene resin beads as hard resin fine particles, alumina as inorganic fine particles, and calcium carbonate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition. The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 3 μm.

### Example 6

A resin composition and a coating composition for forming the substrate protective layer 20 were prepared by the following method.

A binder resin was prepared by blending 10 parts by mass of a curing agent with 46 parts by mass of a polyurethane polyol resin as a main agent, the curing agent being a mixture of equivalent amounts (described as “B” in Table 1) of an adduct of trimethylolpropane and hexamethylene diisocyanate (HDI) and an adduct of trimethylolpropane and tolylene diisocyanate (TDI).

Four types of solid fine particles, i.e., urethane resin beads as soft resin fine particles, acrylic resin beads as hard resin fine particles, silica as inorganic fine particles, and barium carbonate, were used. The average particle diameter of each solid fine particle and the glass transition temperatures Tg of the soft resin fine particles and the hard resin fine particles are shown in Table 1.

Four types of the solid fine particles were blended with the binder resin at the content rate shown in Table 1 to prepare a resin composition, and 50 parts by mass of the resin composition and 100 parts by mass of the solvent were mixed to prepare a coating composition. The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 2 μm.

### Example 7

A resin composition and a coating composition for forming the substrate protective layer 20 were prepared by the following method.

The same binder resin as Example 1 was used.

The same soft resin fine particles and hard resin fine particles as in Example 1 were used as the solid fine particles, and three kinds of silica were used as the inorganic fine particles. The average particle diameter of each solid fine particle and the glass transition temperatures Tg of the soft resin fine particles and the hard resin fine particles are shown in Table 1.

Three types of solid fine particles were blended with the binder resin at the content rate shown in Table 1 to prepare the resin composition, and 50 parts by mass of the resin composition and 100 parts by mass of the solvent were mixed to prepare a coating composition. The total content rate of the solid fine particles in the resin composition was as shown in Table 1.

A seven-layer battery packaging material 2 was prepared in the same manner as in Example 1 except for the resin composition and the coating composition for the substrate protective layer 20. The thickness of the substrate protective layer 20 after aging was 2.5 μm.

### Comparative Example 1

A resin composition and a coating composition for forming the substrate protective layer 20 were prepared by the following method.

The same main agent and curing agent as those of Example 1 were used, and 12 parts by mass of the curing agent was blended with 60 parts by mass of the main agent to prepare a binder resin.

As the solid fine particles, soft resin fine particles were not used, and four kinds of particles, i.e., polystyrene resin beads and acrylic resin beads as hard resin fine particles, and silica, and barium sulfate as inorganic fine particles, were used. The average particle diameter of each solid fine particle and the glass transition temperatures Tg of the soft resin fine particles and the hard resin fine particles are shown in Table 1.

The binder resin was blended with the four kinds of solid fine particles at the contents shown in Table 1 to prepare a resin composition, and 50 parts by mass of the resin composition and 100 parts by mass of a solvent were mixed to prepare a coating composition.

A seven-layer battery packaging material 2 was prepared in the same manner as in Example 1 except for the resin composition and the coating composition for the substrate protective layer 20. The thickness of the substrate protective layer 20 after aging was 3 μm.

### Comparative Example 2

A resin composition and a coating composition for forming the substrate protective layer 20 were prepared by the following method.

The same main agent and curing agent as those of Example 3 were used, and 8 parts by mass of the curing agent was blended with 37 parts by mass of the main agent to prepare a binder resin.

As the solid fine particles, soft resin fine particles were not used, and four kinds of particles, i.e., acrylic resin beads and polytetrafluoroethylene wax as hard resin fine particles, and alumina and barium sulfate as inorganic fine particles, were used. The average particle diameter of each solid fine particle and the glass transition temperatures Tg of the soft resin fine particles and the hard resin fine particles are shown in Table 1.

The binder resin was blended with the four kinds of solid fine particles at the contents shown in Table 1 to prepare a resin composition, and 50 parts by mass of the resin composition and 100 parts by mass of a solvent were mixed to prepare a coating composition. The total content of the solid fine particles in the resin composition is as shown in Table 1.

A seven-layer battery packaging material 2 was prepared in the same manner as in Example 1 except for resin composition and coating composition for the substrate protective layer 20. The thickness of the substrate protective layer 20 after aging was 2 μm.

### Comparative Example 3

A resin composition and a coating composition for forming the substrate protective layer 20 were prepared by the following method.

The same binder resin as Example 1 was used.

As the solid fine particles, soft resin fine particles were not used, acrylic resin beads were used as hard resin fine particles, and three kinds of silica and barium sulfate were used as inorganic fine particles. The average particle diameter of each solid fine particle and the glass transition temperature Tg of the hard resin fine particle are shown in Table 1.

The binder resin was blended with three types of solid fine particles at the contents shown in Table 1 to prepare a resin composition, and 50 parts by mass of the resin composition and 100 parts by mass of a solvent were mixed to prepare a coating composition. The total content of the solid fine particles in the resin composition is as shown in Table 1.

A seven-layer battery packaging material 2 was prepared in the same manner as in Example 1 except for resin composition and coating composition for the substrate protective layer 20. The thickness of the substrate protective layer 20 after aging was 2.5 μm.

### Comparative Example 4

A resin composition and a coating composition for forming the substrate protective layer 20 were prepared by the following method.

The same binder resin as Example 1 was used.

For the solid fine particles, polyethylene wax was not used as the soft resin fine particles, hard resin fine particles were not used, and three kinds of silica and barium sulfate were used as the inorganic fine particles. The average particle diameter of each solid fine particle and the glass transition temperature Tg of the soft resin fine particle are shown in Table 1.

The binder resin was blended with three kinds of solid fine particles at the contents shown in Table 1 to prepare a resin composition, and 50 parts by mass of the resin composition and 100 parts by mass of a solvent were mixed to prepare a coating composition. The total content of the solid fine particles in the resin composition is as shown in Table 1.

A seven-layer battery packaging material 2 was prepared in the same manner as in Example 1 except for the resin composition and the coating composition for the substrate protective layer 20. The thickness of the substrate protective layer 20 after aging was 2.5 μm.

### Comparative Example 5

A resin composition and a coating composition for forming the substrate protective layer 20 were prepared by the following method.

The same binder resin as Example 1 was used.

Three types of solid fine particles, i.e., polyethylene wax as soft resin fine particles, acrylic resin beads as hard resin fine particles, and barium sulfate as inorganic fine particles, were used. The average particle diameter of each solid fine particle and the glass transition temperature Tg of the soft resin fine particle are shown in Table 1.

The binder resin was blended with three kinds of solid fine particles at the contents shown in Table 1 to prepare a resin composition, and 50 parts by mass of the resin composition and 100 parts by mass of a solvent were mixed to prepare a coating composition. The total content of the solid fine particles in the resin composition is as shown in Table 1.

A seven-layer battery packaging material 2 was prepared in the same manner as in Example 1 except for resin composition and coating composition for the substrate protective layer 20. The thickness of the substrate protective layer 20 after aging was 2.5 μm.

TABLE 1

| | | Substrate protective layer Resin composition | | | | | | | | | | |
|---|---|---|---|---|---|---|---|---|---|---|---|---|
| | | | | Solid fine particles | | | | | | | | |
| | | | | Soft resin fine particles | | | | Hard resin fine particles | | | | |
| | | | | | | Ave. | | | | Ave. | | |
| | | Binder resin | | | | particle | Content | | | particle | Content | Inorganic fine |
| | | Main | Curing | | Tg | diameter | rate | | Tg | diameter | rate | particles 1 |
| | | agent | agent | Type | ° C. | μm | mass % | Type | ° C. | μm | mass % | Type |
| Example | 1 | PEs | A | PEW | −30 | 10 | 3 | ACB | 100 | 5 | 5 | Silica |
| | 2 | PEs | A | PEW | −30 | 10 | 5 | PSB | 90 | 5 | 11 | Silica |
| | 3 | AC | A | PEB | −30 | 12 | 8 | PTFE | 126 | 10 | 5 | Alumina |
| | 4 | TFE | A | PEB | −30 | 15 | 6 | PTFE | 126 | 12 | 4 | Silica |
| | 5 | PEs | A | PEW | −30 | 8 | 3 | PSB | 90 | 4 | 5 | Alumina |
| | 6 | PUR | B | URB | −20 | 16 | 6 | ACB | 100 | 10 | 10 | Silica |
| | 7 | PEs | A | PEW | −30 | 10 | 3 | ACB | 100 | 5 | 5 | Silica |
| Comp. | 1 | PEs | A | | | | | PSB | 90 | 3 | 5 | Silica |
| Example | | | | | | | | ACB | 100 | 8 | 2 | |
| | 2 | AC | A | | | | | ACB | 100 | 12 | 10 | Alumina |
| | | | | | | | | PTFE | 126 | 15 | 12 | |
| | 3 | PEs | A | | | | | ACB | 100 | 5 | 3 | Silica |
| | 4 | PEs | A | PEW | −30 | 10 | 3 | | | | | Silica |
| | 5 | PEs | A | PEW | −30 | 10 | 3 | ACB | 100 | 5 | 5 | |

| | | Substrate protective layer Resin composition | | | | | | | | |
|---|---|---|---|---|---|---|---|---|---|---|
| | | Solid fine particles | | | | | | | | |
| | | Inorganic fine | | Inorganic fine | | | | | | |
| | | particles 1 | | particles 2 | | | | | | |
| | | Ava. | | | Ava. | Total | | | | |
| | | Particle | content | | Particle | content | Total | Performance evaluation | | |
| | | diameter | rate | | diameter | rate | Content | | Tape | Adhesive |
| | | μm | mass % | Type | μm | mass % | mass % | Moldability | adhesiveness | residues |
| Example | 1 | 1 | 22 | Ba sulfate | 2 | 5 | 35 | ⊚ | ⊚ | ⊚ |
| | 2 | 1 | 6 | Ba sulfate | 2 | 16 | 38 | ⊚ | ⊚ | ⊚ |
| | 3 | 2 | 20 | Ba sulfate | 2 | 10 | 43 | ⊚ | ⊚ | ⊚ |
| | 4 | 1 | 10 | Ba sulfate | 1 | 25 | 45 | ⊚ | ⊚ | ⊚ |
| | 5 | 1 | 16 | Ca barium | 2 | 7 | 31 | ◯ | ⊚ | ◯ |
| | 6 | 1 | 12 | Ba sulfate | 3 | 20 | 48 | ⊚ | ◯ | ⊚ |
| | 7 | 1 | 27 | | | | 35 | ⊚ | ⊚ | ⊚ |
| Comp. | 1 | 1 | 6 | Ba sulfate | 1 | 12 | 25 | X | ⊚ | X |
| Example | 2 | 2 | 15 | Ba sulfate | 1 | 18 | 55 | ⊚ | X | ⊚ |
| | 3 | 1 | 20 | Ba sulfate | 2 | 5 | 28 | X | X | X |
| | 4 | 1 | 20 | Ba sulfate | 2 | 5 | 28 | X | ⊚ | Δ |
| | 5 | | | Ba sulfate | 2 | 5 | 13 | X | ⊚ | X |

In Tables 1, the abbreviations for the main agent, the soft resin fine particles and the hard resin fine particles are as follows.

### Main Agent

PEs: polyester polyol plastic,
AC: Acrylic polyol
TFE: Copolymer of tetrafluoroethylene and carboxylic acid vinylester
PUR: Polyurethane polyol

### Soft Resin Fine Particles

PEW: polyethylene wax,
PEB: polyethylene resin beads
URB: urethane resin beads
PPW: polypropylene wax

### Hard Resin Fine Particles

ACB: acrylic resin beads
PTFE: polytetrafluoroethylene wax
PSB: polystyrene resin beads

Battery packaging material 2 was measured and evaluated for the following items. The results are shown in Table 1.

### Formability

A plurality of 100 mm×125 mm of test pieces were cut out from the produced battery packaging material 2 using a molding machine manufactured by Amada Co., Ltd. (part number: TP-25C-XZ), deep drawing was performed at different depths by using a punch having a top surface dimension of 33 mm×54 mm, a corner of R2 mm, a punch shoulder of R1.3 mm and a die having a die shoulder of R1 mm.

For deep drawn molded articles, the presence or absence of pinholes and cracks at the corners was examined by a light-transmitting method in a dark room, and the depth at which no pinholes and no cracks occurred were set as the largest molded depth (mm) of the battery packaging material 2. The maximal molded depth was evaluated based on the below criteria in which ⊚ and ◯ are accepted (passed).
⊚: Maximum molded depth is 5.5 mm or more
◯: Maximum molded depth 4.5 mm to 5.5 mm
X: Maximum molded depth is less than 4.5 mm

### Tape Adhesive Properties

A test piece with a width 15 mm×a length 150 mm was cut out from the battery packaging material 2. An adhesive tape (tesa 70415) having a width 5 mm and a length 80 mm and having an adhesive force of 13 N/cm was adhered to the substrate protective layer 20 of the test piece along the longitudinal direction of the test piece. Then, a hand roll having a weight 2 kgf was made to travel back and forth five times on the adhesive tape, and then allowed to stand at a normal temperature for one hour.

Next, a tensile test machine using an AGS-5kNX manufactured by Shimadzu Corporation was used to pinch and fix the end portion of the test piece with one chuck, and the other chuck was used to grasp the other end portion of adhesive tape. In accordance with JIS K6854-3 (1999), the peeling strength was measured when the tape was peeled off at 180 degrees at the peeling rate of 300 mm/min, and the value at which the measured value was stabilized was defined as the adhesive force (unit: N/mm) between the test piece and the adhesive tape.

Then, the adhesive force between the test piece and the adhesive tape was evaluated according to the following criteria, and ⊚ and ◯ were considered as accepted (Passed).
⊚: 7 N/5 mm or more, and the adhesiveness is very high
◯: 5N/5 mm or more and less than 7N/5 mm, and the adhesiveness is high
X: Less than 5 N/5 mm, and the adhesiveness is low

### Adhesive Residues

A test piece with a width 50 mm×a length 100 mm was cut out from the battery packaging material 2. An adhesive tape (Nitto Denko V420) having a width of 40 mm and a length of 60 mm and having an adhesive strength of 0.1 N/cm was adhered to the substrate protective layer 20 of the test piece along the longitudinal direction of the test piece. Then, a hand roll having a weight 2 kgf was made to travel five times back and forth on the adhesive tape. The test piece to which the above adhesive tape was applied was then heat-pressed with a 80° C.×0.5 MPa.

Then, the adhesive tape was quickly peeled off from the test piece after the series of processes, and the peeled surface was observed, and evaluated according to the following criteria, and the ⊚, ◯, Δ was considered as acceptable (Passed).
⊚: No change in the surface status as compared with the pre-adhering
◯: There was a piece of adhesive that could be removed by wiping it lightly.
Δ: It could be removed by wiping, but a piece of adhesive larger than “◯” remained
X: Adhesive that could not be removed by wiping remained firmly.

From Tables 1, it was confirmed that, by specifying solid fine particles of the substrate protective layer, adhesive properties of protective tape is good, and the adhesive residue at the time of peeling can be suppressed.

### INDUSTRIAL APPLICABILITY

The battery packaging material according to the present invention can be suitably used as a packaging material for a power storage device, such as, e.g., a battery or a capacitor used for a mobile device exemplified by a smartphone and a tablet computer, and a battery or a capacitor used for an electric vehicle, wind power generation, solar power generation, or storing night power.

This application claims priority to Japanese Patent Application No. 2022-68030 filed on Apr. 18, 2022, and Japanese Patent Application No. 2023-40789 filed on Mar. 15, 2023, the disclosure of which is incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### DESCRIPTION OF SYMBOLS

1, 2: Battery packaging material
11: Barrier Layer
12: First adhesive layer
13: Substrate layer
14: Second adhesive layer
15: Heat-fusible resin layer
16: Colored layer
20: Substrate Protective Layer
21: Binder resin
22: Solid fine particles
22a: Soft resin fine particles
22b: Hard resin fine particles
22c: Inorganic fine particles
30: Protrusion

1. A battery packaging material comprising:
a substrate layer;
a heat-fusible resin layer;
a barrier layer arranged between the substrate layer and the heat-fusible resin layer; and
a substrate protective layer as an outermost layer arranged on an outer side of the substrate layer,
wherein the substrate protective layer contains a binder resin, soft resin fine particles having a glass transition temperature Tg of less than 30° C., hard resin fine particles having a glass transition temperature Tg of 30° C. or higher, and inorganic fine particles, as solid fine particles, and
wherein a total content rate of the solid fine particles in the substrate protective layer is 30 mass % to 50 mass %.

2. The battery packaging material as recited in claim 1,
wherein the soft resin fine particles have an average particle diameter of 5 μm to 20 μm, the hard resin fine particles have an average particle diameter of 1 μm to 15 μm, and the inorganic fine particles have an average particle diameter of 1 μm to 10 μm.

3. The battery packaging material as recited in claim 1,
wherein in the substrate protective layer, a content rate of the soft resin fine particles is 1 mass % to 10 mass %, a content rate of the hard resin fine particles is 1 mass % to 20 mass %, and a content rate of the inorganic fine particles is 20 mass % to 40 mass %.

4. The battery packaging material as recited in claim 1,
wherein the soft resin fine particles are at least one selected from the group consisting of polyethylene wax, polypropylene wax, polyethylene resin beads, and urethane resin beads.

5. The battery packaging material as recited in claim 1,
wherein the hard resin fine particles are at least one selected from the group consisting of polytetrafluoroethylene wax, acrylic resin beads, polystyrene resin beads, and fluororesin beads.

6. The battery packaging material as recited in claim 1,
wherein the inorganic fine particles are at least one selected from the group consisting of silica, alumina, kaolin, calcium oxide, calcium carbonate, calcium sulfate, barium sulfate, and calcium silicate.

7. The battery packaging material as recited in claim 1,
wherein the binder resin of the substrate protective layer is at least one selected from the group consisting of an acryl-based resin, a urethane-based resin, a polyolefin-based resin, a phenoxy-based resin, a polyester-based resin, a tetrafluoro olefin-based resin.

8. The battery packaging material as recited in claim 1,
wherein at least one of the substrate protective layer and the substrate layer contains a coloring agent.

9. The battery packaging material as recited in claim 1,
wherein the barrier layer and the substrate layer are laminated via an adhesive layer, and at least one of the substrate protective layer, the substrate layer, and the adhesive layer contains a coloring agent.

10. The battery packaging material as recited in claim 1, further comprising:
a colored layer provided at least one of between the substrate protective layer and the substrate layer, and between the substrate layer and the barrier layer.

11. The battery packaging material as recited in claim 1,
wherein the barrier layer and the substrate layer are laminated via an adhesive layer, and
wherein a colored layer is provided at least one between the substrate protective layer and the substrate layer, between the substrate layer and the adhesive layer, and between the adhesive layer and the barrier layer.
